(19) United States
(12) Patent Application Publication
(10) Pub. No.: US 2010/0328038 A1
(43) Pub. Date: Dec. 30, 2010

(54) WIRELESS TAG READING APPARATUS AND METHOD FOR ARRANGING READER ANTENNA OF WIRELESS TAG READING APPARATUS

(75) Inventor: Masakazu KATO, Shizuoka (JP)

Correspondence Address: PATTERSON & SHERIDAN, L.L.P., 3040 POST OAK BOULEVARD, SUITE 1500, HOUSTON, TX, 77056, US

(73) Assignee: TOSHIBA TEC KABUSHIKI KAISHA, Tokyo (JP)

(21) Appl. No.: 12/790,421

(22) Filed: May 28, 2010

(30) Foreign Application Priority Data
Jun. 29, 2009 (JP) 2009-153869

(51) Int. Cl. H04Q 5/22

(52) U.S. Cl. 340/10.1

(57) ABSTRACT

A wireless tag reading apparatus comprising: an electric field-type reader antenna which has an electromagnetic wave radiating side arranged toward a wireless tag for both near-field and far-field operation and which transmits and receives a signal to and from the wireless tag by an electric field; a magnetic field-type reader antenna which has an electromagnetic wave radiating side arranged toward the wireless tag from a different direction from the electromagnetic wave radiating side of the electric field-type reader antenna and not orthogonally to an antenna side of the wireless tag and which transmits and receives a signal to and from the wireless tag by a magnetic field; and an antenna switching unit which switches use of the magnetic field-type reader antenna and the electric field-type reader antenna.

### CROSS-REFERENCE TO RELATED APPLICATION

This application is based upon and claims the benefit of priority from Japanese Patent Application No. 2009-153869 filed on Jun. 29, 2009, the entire contents of which are incorporated herein by reference.

### TECHNICAL FIELD

Embodiment described herein relates to a wireless tag reading apparatus and a method for arranging a reader antenna of a wireless tag reading apparatus.

### BACKGROUND

In a wireless tag reading apparatus, plural articles having a wireless tag attached to them are housed in a housing case and ID and data stored in the wireless tag are read via a reader antenna arranged outside the housing case. Articles to be reading targets of the wireless tag reading apparatus and housed in the housing case include, for example, mails.

For example, a wireless tag reading apparatus disclosed in JP-A-2002-37425 has a housing case that is partitioned in predetermined spacing by plural partition boards on which an antenna is arranged. In the wireless tag reading apparatus, mails with a wireless tag attached to them are housed one by one in each of the partitioned spaces and data is read from a corresponding wireless tag via the antenna arranged on each partition board. Thus, the wireless tag reading apparatus disclosed in JP-A-2002-37425 solves the problem that if wireless tags are stacked, data cannot be read from the stacked wireless tags.

Other than this apparatus, techniques that enable reading data from plural stacked wireless tags are developed recently.

For example, in a wireless tag reading apparatus disclosed in JP-A-2005-327099, a passive element is arranged between a case in which plural articles having a wireless tag attached to them are arrayed and housed and a reader antenna arranged near the case, thus realizing satisfactory reading from stacked wireless tags. The wireless tag reading apparatus disclosed in JP-A-2005-327099 is a technique assuming that envelopes with a wireless tag attached to them are arrayed in an upright position on the reader antenna and data is read from these envelopes. In the wireless tag reading apparatus disclosed in JP-A-2005-327099, since the passive element is arranged between the wireless tags and the reader antenna, the reader antenna and the wireless tag operate via an electric field.

Meanwhile, a wireless tag for both near-field and far-field operation is recently used as an item level tag. In the item level tag, a dipole antenna which responds to an electric field is provided on the outside of a small loop antenna which operates via a magnetic field. Thus, the item level tag operates both via a magnetic field and an electric field.

However, there is no established technique for reading data from such wireless tags for both near-field and far-field operation in a stacked state.

### DESCRIPTION OF THE DRAWINGS

FIG. 1 shows the configuration of a wireless tag reading apparatus as a first embodiment of the invention.

FIG. 2 shows an example of the configuration of a magnetic field-type reader antenna.

FIG. 3 shows the configuration of an interrogator.

FIG. 4 shows an example of the configuration of a wireless tag for both near-field and far-field operation.

FIG. 5 shows the positional relation between two reader antennas and stacked wireless tags.

FIG. 6 shows the result of reading (where L=3 cm).

FIG. 7 shows the configuration of a wireless tag reading apparatus as a second embodiment.

FIG. 8 shows the configuration of a wireless tag reading apparatus as a third embodiment.

### DETAILED DESCRIPTION

According to one embodiment, a wireless tag reading apparatus includes: an electric field-type reader antenna which has an electromagnetic wave radiating side arranged toward a wireless tag for both near-field and far-field operation and which transmits and receives a signal to and from the wireless tag by an electric field; a magnetic field-type reader antenna which has an electromagnetic wave radiating side arranged toward the wireless tag from a different direction from the electromagnetic wave radiating side of the electric field-type reader antenna and not orthogonally to an antenna side of the wireless tag and which transmits and receives a signal to and from the wireless tag by a magnetic field; and an antenna switching unit which switches use of the magnetic field-type reader antenna and the electric field-type reader antenna.

According to another embodiment, a method for arranging a reader antenna of a wireless tag reading apparatus includes, in a wireless tag reading apparatus having an electric field-type reader antenna which transmits and receives a signal to and from a wireless tag for both near-field and far-field operation by an electric field, a magnetic field-type reader antenna which transmits and receives a signal to and from the wireless tag by a magnetic field, and an antenna switching unit which switches use of the magnetic field-type reader antenna and the electric field-type reader antenna: arranging an electromagnetic wave radiating side of the magnetic field-type reader antenna toward the wireless tag arranged and not to be orthogonal to an antenna side of the wireless tag; and arranging an electromagnetic wave radiating side of the electric field-type reader antenna oppositely to the electromagnetic wave radiating side of the magnetic field-type reader antenna.

According to still another embodiment, a method for arranging a reader antenna of a wireless tag reading apparatus includes, in a wireless tag reading apparatus having an electric field-type reader antenna which transmits and receives a signal to and from a wireless tag for both near-field and far-field operation by an electric field, a magnetic field-type reader antenna which transmits and receives a signal to and from the wireless tag by a magnetic field, and an antenna switching unit which switches use of the magnetic field-type reader antenna and the electric field-type reader antenna: arranging an electromagnetic wave radiating side of the magnetic field-type reader antenna toward the wireless tag arranged and not to be orthogonal to an antenna side of the wireless tag; and arranging an electromagnetic wave radiating side of the electric field-type reader antenna along a direction of stack of the wireless tags and to intersect the electromagnetic wave radiating side of the magnetic field-type reader antenna.

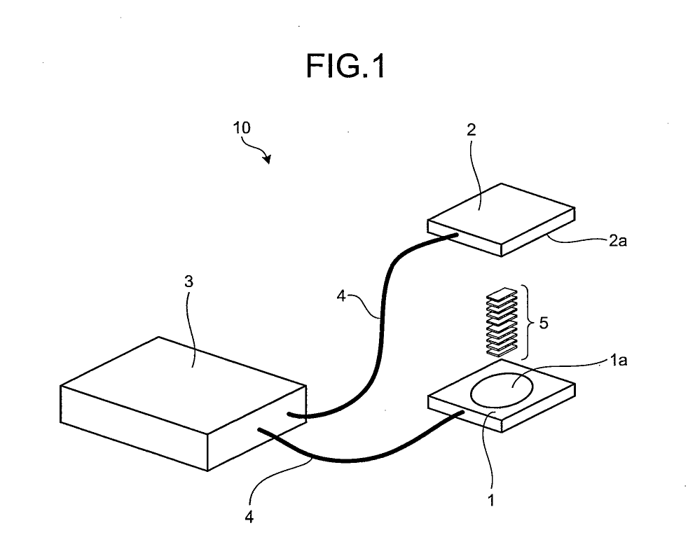

FIG. 1 shows the configuration of a wireless tag reading apparatus as a first embodiment. As shown in FIG. 1, a wireless tag reading apparatus 10 has a magnetic field-type reader antenna 1, an electric field-type reader antenna 2, and an interrogator 3. In the wireless tag reading apparatus 10, an electromagnetic wave radiating side 1a of the magnetic field-type reader antenna 1 and an electromagnetic wave radiating side 2a of the electric field-type reader antenna 2 are arranged oppositely to each other. In the wireless tag reading apparatus 10, the magnetic field-type reader antenna 1 and the electric field-type reader antenna 2 are connected to the interrogator 3 via a coaxial cable 4. With the wireless tag reading apparatus 10 having this configuration, data can be read from all wireless tags 5 stacked and placed between the magnetic field-type reader antenna 1 and the electric field-type reader antenna 2. The wireless tags 5 as reading targets are actually attached to articles such as mails, envelopes and documents. However, in this description, only the wireless tags are show and described for simplification.

The configuration of the wireless tag reading apparatus 10 will be described more specifically.

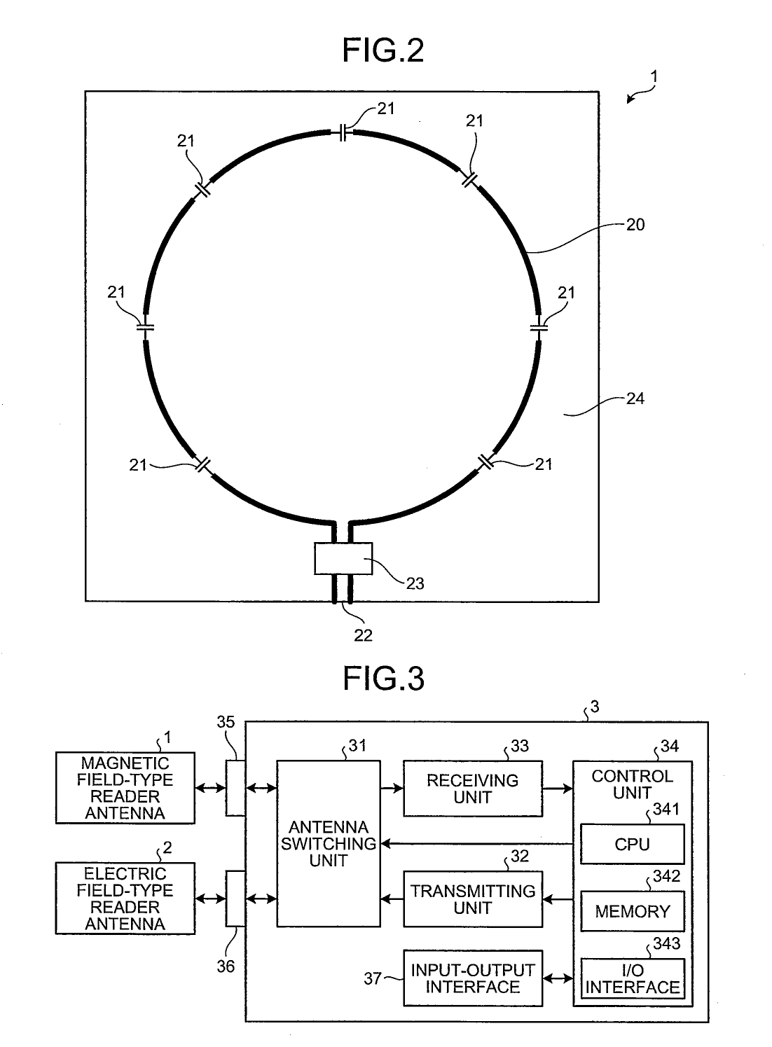

The magnetic field-type reader antenna 1 is loop-shaped, as shown in FIG. 2. More specifically, in the magnetic field-type reader antenna 1, a circular loop 20 made of a conductor and formed on a substrate 24 is divided into plural parts and the spacing between parts is connected by a capacitor 21. Thus, a desired resonance frequency is acquired. The magnetic field-type reader antenna 1 has a balun 23 for unbalance-balance conversion in order to connect an unbalanced coaxial cable to a feeding point 22.

In the magnetic field-type reader antenna 1, the loop 20 has a diameter of about 10 cm and each capacitor 21 has a capacitance of approximately 1 pF. Thus, the magnetic field-type reader antenna 1 can be tuned to the resonance frequency of 953 MHz, which is the center of the frequency range used in Japan. However, since the resonance frequency changes depending on the type of the substrate 24 used, its environment and the like, the diameter of the loop 20, the number of divisions of the loop 20, the capacitance value of the capacitors 21 used and the like need to be adjusted properly. The magnetic field-type reader antenna 1 is an RFID magnetic field-type reader antenna for the UHF band which is now used increasingly broadly.

Meanwhile, the electric field-type reader antenna 2 is a so-called patch antenna which is often used conventionally. However, the electric field-type reader antenna 2 is not limited to this patch antenna. By the way, a linear polarization-type patch antenna is formed by arranging a square conductor pattern with about ½ wavelength on a substrate having a layered structure in which a conductor pattern and a grounded conductor face each other with a dielectric laid between them and then providing a feeding part for generating resonance (not shown).

Next, the schematic configuration of the interrogator 3 will be described with reference to FIG. 3. FIG. 3 is a block diagram showing the schematic configuration of the interrogator 3.

The interrogator 3 has an antenna switching unit 31, a transmitting unit 32, a receiving unit 33, a control unit 34, and an input-output interface 37. The interrogator 3 including the antenna switching unit 31 has at least two antenna connection terminals 35,36 to be connected to each of the magnetic field-type reader antenna 1 and the electric field-type reader antenna 2.

The control unit 34 has a CPU (central processing unit) 341, a memory 342 for storing a control program for the CPU and various data, and an input-output interface (I/O interface) 343 for connection to each of the transmitting unit 32, the receiving unit 33 and other devices. The control unit 34 generates transmission data to be transmitted to a wireless tag as a reading target and supplies the transmission data to the transmitting unit 32. The control unit 34 also decodes received data supplied form the receiving unit 33.

The transmitting unit 32 generates an analog signal from the transmission data from the control unit 34, then modulates this signal with a frequency in the 953-MHz band, and amplifies the signal so that the signal can be outputted from an antenna terminal with a prescribed output. The prescribed output is, for example, 1 W, which is the maximum output value defined by the Radio Law.

The antenna switching unit 31 switches between the magnetic field-type reader antenna 1 and the electric field-type reader antenna 2 in accordance with a control signal outputted form the control unit 34. Although timing of switching each antenna is not particularly prescribed, for example, a technique of switching every predetermined time period (for example, several ten ms to several hundred ms) can be employed. Also, a technique of not switching while data is received via one antenna from the stacked wireless tags 5 and then switching to the other antenna when data can no longer be received can be employed as well. Moreover, if the total number of the stacked wireless tags 5 is known in advance (for example, if the total number of the stacked wireless tags 5 is inputted and set in the interrogator 3), when one antenna cannot read data from the all the wireless tags 5, it is possible to switch to the other antenna and read data.

In the wireless tag reading apparatus 10, a reflected wave which is response signal from the wireless tag 5 is received by an antenna selected at the time of transmission. The receiving unit 33 demodulates the received response signal, generates digital received data from the demodulated signal and supplies the received data to the control unit 34. The control unit 34 decodes the received data.

The interrogator 3 has an input-output interface such as LAN or RS232C. A PC (personal computer) functioning as a host connected via the input-output interface of the interrogator 3 controls the interrogator 3.

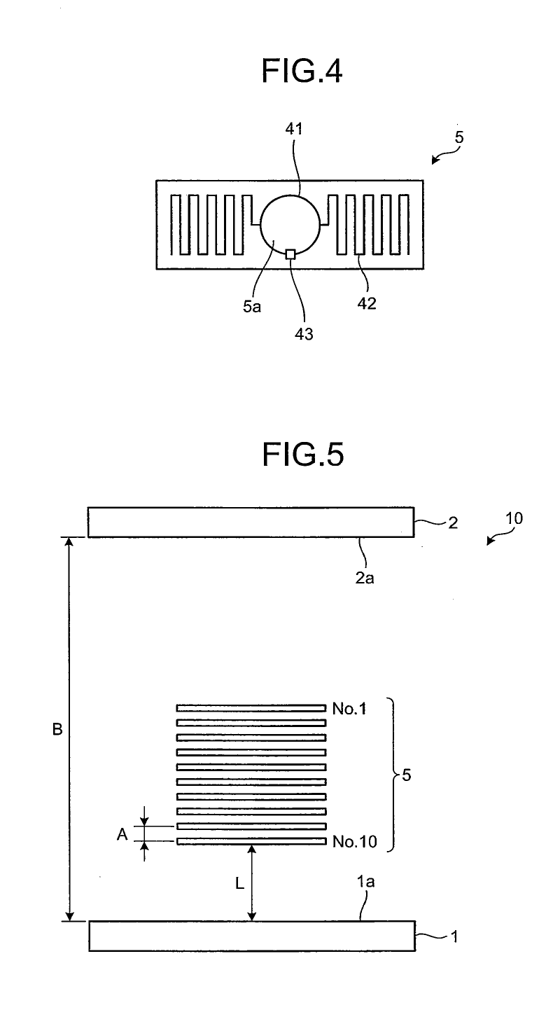

The wireless tag 5 is a wireless tag for both near-field and far-field operation having a loop antenna 41 which can respond with a magnetic field and a dipole antenna 42 which can respond with an electric field, as shown in FIG. 4. The wireless tag 5 has an IC chip 43 mounted on it and the loop antenna 41 having a diameter of approximately 10 mm is connected to the IC chip 43.

The dipole antenna 42 can be reduced in the outer shape by being folded in multiple layers. As the dipole antenna 42 used in the 953-MHz band, a dipole antenna with a size of approximately 10 mm by 30 mm is distributed and classified as a item level tag. For example, a tag called Mini-Squiggle having a Higgs-IC chip mounted on it, made by Alien Technology, has the configuration as described above. This embodiment assumes that the wireless tag for both near-field and far-field operation 5 as described above is used and data is read from this tag.

FIG. 5 is a side view showing the positional relation between the magnetic field-type reader antenna 1, the electric field-type reader antenna 2 and the stacked wireless tags 5.

In the wireless tag reading apparatus 10, the magnetic field-type reader antenna 1 is placed in the lower side in the gravitational direction and its electromagnetic wave radiating side 1a is arranged facing upward in the gravitational direction. More specifically, in the wireless tag reading apparatus 10, the magnetic field-type reader antenna 1 is arranged in such a manner that at least its electromagnetic wave radiating side 1a faces the space where the stacked wireless tags 5 are arranged, and not orthogonally to each antenna side 5a (the antenna side of the loop antenna 41) of the wireless tags 5 stacked and arranged in this space. The reason for arranging the magnetic field-type reader antenna 1 as above is that this antenna is a magnetic field-type antenna which transmits and receives signals to and from the loop antenna 41 of the wireless tags 5 by using a magnetic field component.

Meanwhile, in the wireless tag reading apparatus 10, the electric field-type reader antenna 2 is arranged oppositely to the magnetic field-type reader antenna 1. That is, in the wireless tag reading apparatus 10, the electric field-type reader antenna 2 is arranged on the upper side in the gravitational direction with its electromagnetic wave radiating side 2a facing downward in the gravitational direction.

The wireless tag reading apparatus 10 reads data in the state where the wireless tags 5 (in practice, articles with the wireless tags 5 attached to them) stacked in the space between the magnetic field-type reader antenna 1 and the electric field-type reader antenna 2 remain stacked. The positions of the wireless tags and the reader antennas are not particularly prescribed in detail. However, for instance, in the wireless tag reading apparatus 10 in the example shown in FIG. 5, a spacing A between wireless tags 5 is about 2 mm and a distance B between the magnetic field-type reader antenna 1 and the electric field-type reader antenna 2 is about 20 cm.

When the wireless tag reading apparatus 10 reads data from the stacked wireless tags 5 by using the magnetic field-type reader antenna 1, reading near the magnetic field-type reader antenna 1 is good because of the characteristics of magnetic fields. However, reading deteriorates if the wireless tags are away from the magnetic field-type reader antenna 1. A 13.56-MHz IC tag operating via a magnetic field (for example, Suica (trademark registered)) is a typical example. At a gate in a station, reading can be secured if a Suica card is held almost in contact with a reader. It is similarly true with the UHF band that data can only be read from the vicinity. If a distance L between the bottom end of the bunch of wireless tags 5 (the stacked wireless tags 5) and the magnetic field-type reader antenna 1 shown in FIG. 5 is 1 to 2 cm, it is possible to read data from all the ten stacked wireless tags 5. However, if the distance L expands to approximately 3 cm, reading failure occurs.

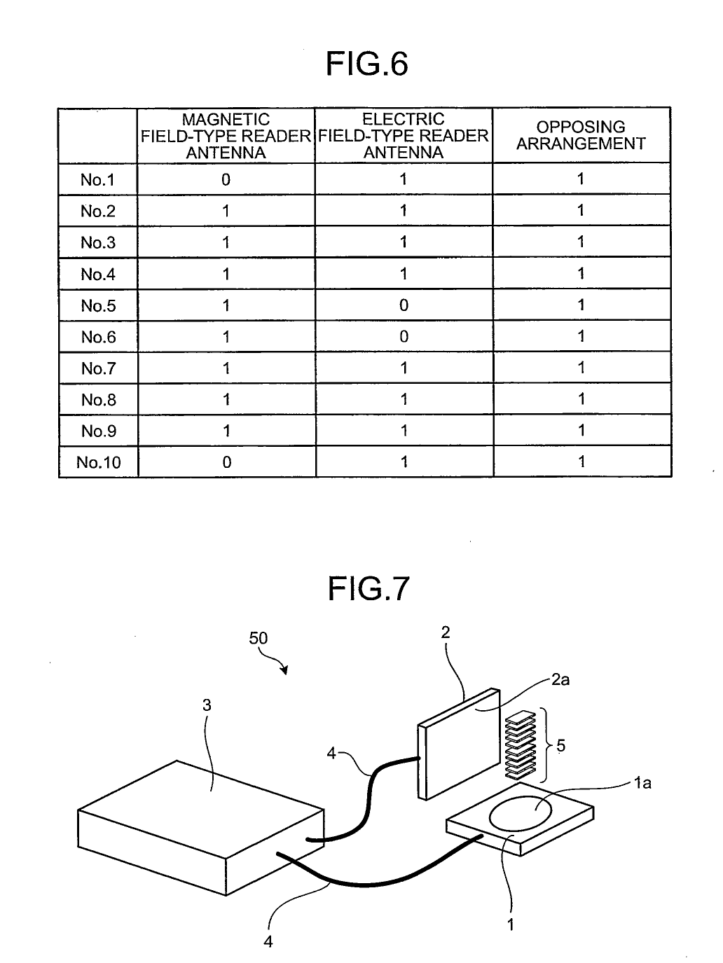

FIG. 6 shows the result of reading in the case of L=3 cm. In FIG. 6, “1” indicates that data can be read and “0” indicates that data cannot be read from the ten stacked wireless tags 5. The example of FIG. 6 shows that when the wireless tag reading apparatus 10 reads data from the ten stacked wireless tags 5 by only using the magnetic field-type reader antenna 1, the reading is not successful from the uppermost and lowermost wireless tags No. 1 and No. 10. This phenomenon is peculiar to the electric-magnetic field common wireless tags 5. Although the mechanism is not successfully analyzed in detail, the phenomenon that data can be read from those close the center of the stacked wireless tags 5 but not from those at the edges, occurs often.

Meanwhile, when the wireless tag reading apparatus 10 reads data from the same ten stacked wireless tags 5 by using the electric field-type reader antenna 2, data cannot be read from the wireless tags No. 5 and No. 6 in the center. The phenomenon that, in the case of reading stacked wireless tags using an electric field-type reader antenna, data cannot be read from wireless tags in the center, is conventionally known.

Thus, in the wireless tag reading apparatus 10, the magnetic field-type reader antenna 1 and the electric field-type reader antenna 2 are arranged oppositely to each other and the interrogator 3 switches the use of the magnetic field-type reader antenna 1 and the electric field-type reader antenna 2 so as to complement each other for non-readable parts. Thus, it is possible to read data from all the ten stacked wireless tags 5.

Next, a wireless tag reading apparatus as a second embodiment will be described.

The wireless tag reading apparatus 10 according to the first embodiment is described as having the magnetic field-type reader antenna 1 and the electric field-type reader antenna 2 arranged oppositely to each other. On the other hand, in a wireless tag reading apparatus 50 according to the second embodiment, the electric field-type reader antenna 2 is arranged along the direction of the stack of the wireless tags and with its electromagnetic wave radiating side 2a intersecting (for example, orthogonal to) the electromagnetic wave radiating side 1a of the magnetic field-type reader antenna 1, as shown in FIG. 7.

The electric field-type reader antenna 2 transmits and receives signals to and from the dipole antenna 42 of the wireless tag by an electric field. Therefore, it suffices that its electromagnetic wave radiating side 2a faces the space where the stacked wireless tags 5 are arranged. Other parts of the configuration are similar to those of the first embodiment and therefore will not be described further in detail. This embodiment has advantages similar to those of the first embodiment.

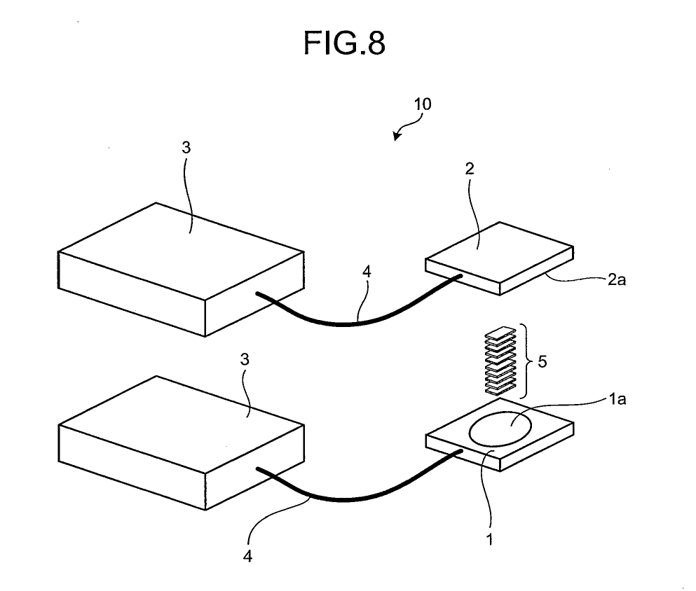

Next, a wireless tag reading apparatus as a third embodiment will be described with reference to FIG. 8.

Each of the above embodiments has the configuration in which switching between the two types of reader antenna is performed within the interrogator 3 and data is then read from the stacked wireless tags 5. However, the two types of reader antennas may be separately connected to their respective separate interrogators and each of the interrogators may perform reading from the stacked wireless tags 5. In this case, the two interrogators complement each other for non-readable parts of the stacked wireless tags 5. Control to realize this complementation can be carried out by the host PC or the like which controls each interrogator.

Although not shown in FIG. 1 or FIG. 7, the magnetic field-type reader antenna 1 and the electric field-type reader antenna 2 are attached in the above-described positional relation with a housing article (not shown) such as a housing case or shelf which houses articles (mails, envelopes, documents or the like) having the wireless tag 5 attached to them. The magnetic field-type reader antenna 1 and the electric field-type reader antenna 2 are thus arranged. Of course, the magnetic field-type reader antenna 1 and the electric field-type reader antenna 2 may also be attached to the hosing article in the process where the housing article is manufactured, or may be attached to an already manufactured housing article.

While certain embodiments have been described, these embodiments have been presented by way of example only, and are not intended to limit the scope of the inventions. Indeed, the novel apparatus and methods described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless tag reading apparatus comprising:
an electric field-type reader antenna which has an electromagnetic wave radiating side arranged toward a wireless tag for both near-field and far-field operation and which transmits and receives a signal to and from the wireless tag by an electric field;
a magnetic field-type reader antenna which has an electromagnetic wave radiating side arranged toward the wireless tag from a different direction from the electromagnetic wave radiating side of the electric field-type reader antenna and not orthogonally to an antenna side of the wireless tag and which transmits and receives a signal to and from the wireless tag by a magnetic field; and
an antenna switching unit which switches use of the magnetic field-type reader antenna and the electric field-type reader antenna.

2. The apparatus according to claim 1, wherein the electric field-type reader antenna is arranged with the electromagnetic wave radiating side of the electric field-type reader antenna oppositely to the electromagnetic wave radiating side of the magnetic field-type reader antenna.

3. The apparatus according to claim 1, wherein the electric field-type reader antenna is arranged along a direction of stack of the wireless tags and with the electromagnetic wave radiating side of the electric field-type reader antenna intersecting the electromagnetic wave radiating side of the magnetic field-type reader antenna.

4. The apparatus according to claim 1, wherein the magnetic field-type reader antenna is arranged in a lower part in a gravitational direction with the electromagnetic wave radiating side of the magnetic field-type reader antenna facing upward in the gravitational direction.

5. The apparatus according to claim 1, further comprising an interrogator which generates a query signal to make an inquiry to the wireless tag, outputs the query signal to the electric field-type reader antenna or the magnetic field-type reader antenna, receives a response signal from the wireless tag received by the electric field-type reader antenna or the magnetic field-type reader antenna, and demodulates and decodes the response signal, and
wherein the interrogator includes the antenna switching unit and switches between the electric field-type reader antenna and the magnetic field-type reader antenna by the antenna switching unit, transmits the query signal to the wireless tag, and receives the response signal.

6. The apparatus according to claim 1, wherein the antenna switching unit switches between the electric field-type reader antenna and the magnetic field-type reader antenna every predetermined time period.

7. The apparatus according to claim 1, wherein the antenna switching unit does not switch while data is received from the wireless tag via one reader antenna of the electric field-type reader antenna and the magnetic field-type reader antenna, and switches to the other reader antenna when data can no longer be received from the wireless tag.

8. The apparatus according to claim 1, wherein if the total number of the wires tags as a reading target is known in advance and reading cannot be done from the total number of the wireless tags via one reader antenna of the electric field-type reader antenna and the magnetic field-type reader antenna, the antenna switching unit switches to the other reader antenna.

9. The apparatus according to claim 1, wherein the electric field-type reader antenna and the magnetic field-type reader antenna are provided on a housing article which houses an article having the wireless tag attached thereto.

10. A method for arranging a reader antenna of a wireless tag reading apparatus comprising, in a wireless tag reading apparatus having an electric field-type reader antenna which transmits and receives a signal to and from a wireless tag for both near-field and far-field operation by an electric field, a magnetic field-type reader antenna which transmits and receives a signal to and from the wireless tag by a magnetic field, and an antenna switching unit which switches use of the magnetic field-type reader antenna and the electric field-type reader antenna:
arranging an electromagnetic wave radiating side of the magnetic field-type reader antenna toward the wireless tag arranged and not to be orthogonal to an antenna side of the wireless tag; and
arranging an electromagnetic wave radiating side of the electric field-type reader antenna oppositely to the electromagnetic wave radiating side of the magnetic field-type reader antenna.

11. A method for arranging a reader antenna of a wireless tag reading apparatus comprising, in a wireless tag reading apparatus having an electric field-type reader antenna which transmits and receives a signal to and from a wireless tag for both near-field and far-field operation by an electric field, a magnetic field-type reader antenna which transmits and receives a signal to and from the wireless tag by a magnetic field, and an antenna switching unit which switches use of the magnetic field-type reader antenna and the electric field-type reader antenna:
arranging an electromagnetic wave radiating side of the magnetic field-type reader antenna toward the wireless tag arranged and not to be orthogonal to an antenna side of the wireless tag; and
arranging an electromagnetic wave radiating side of the electric field-type reader antenna along a direction of stack of the wireless tags and to intersect the electromagnetic wave radiating side of the magnetic field-type reader antenna.
